(19) United States
(12) Patent Application Publication
(10) Pub. No.: US 2008/0304277 A1
(43) Pub. Date: Dec. 11, 2008

(54) INCREASED EFFICIENCY LED PROJECTOR OPTIC ASSEMBLY

(76) Inventors: JEYACHANDRABOSE CHINNIAH, Belleville, MI (US); Amir P. Fallahi, W. Bloomfield, MI (US); Edwin Mitchell Sayers, Saline, MI (US); Chirstopher L. Eichelberger, Livonia, MI (US)

Correspondence Address: VISTEON/BRINKS HOFER GILSON & LIONE, 524 South Main Street, Suite 200, Ann Arbor, MI, 48104, US

(21) Appl. No.: 11/759,402

(22) Filed: Jun. 7, 2007

(51) Int. Cl. B60Q 11/00

(52) U.S. Cl. 362/507

(57) ABSTRACT

A projector optic assembly for generating and projecting a high gradient beam. The assembly includes a light pipe defining an optical axis and having a collection unit, a funneling unit, and an emitting surface. The collection unit extends from a first end to a transition plane defining the transition from the collection unit to the funneling unit. The collection unit is configured to collect light from a source and direct it through the transition plane, whereafter the funneling unit extends from the transition plane to the emitting surface. The emitting surface has an area smaller than an area of the transition plane selected to increase the efficiency of the funneling unit. Spaced apart from and generally opposite of the emitting surface is a condenser lens

### BACKGROUND

1. Field of the Invention

The present invention generally relates to motor vehicle headlamps. More specifically, the invention relates to projector headlamp assemblies including light emitting diodes and which lack a reflector.

2. Description of Related Art

It is well known to use light emitting sources, including light emitting diodes (LEDs), Lambertian emitters, 2π emitters, and fiber optic light guide tips, in a variety of applications, including, but not limited to, vehicular applications. With regard to LED sources, these sources are increasingly finding use in automotive, commercial, and general lighting applications since their light outputs have increased exponentially and their costs have fallen significantly over the past few years. LEDs are attractive due to their small size and the fact that they consume less power relative to incandescent light sources. The popularity of LEDs as light sources is expected to continue and increase as their potential benefits are further developed, particularly with respect to increased light output.

Today's LEDs come in different sizes and different emitting cone angles, ranging from 15 degrees (forward emitting or side emitting) to 180 degrees (hemispherical emitting). An emitting cone angle is typically referred to as 2φ. It is therefore very important to construct efficient light collection assemblies to harness the maximum possible light output from LEDs and to direct it in a predetermined and controlled manner.

For some applications, such as a projector optic assembly for use as an automotive headlight, it is important to project a high gradient beam pattern. High gradient beam patterns have a defined beam pattern shape with varying degrees of light intensity within the beam pattern. Specifically, the beam pattern should have a certain amount of vertical spread as well as a certain amount of horizontal spread and a vertical cut-off should be provided to minimize glare to oncoming traffic.

One example of existing LED projector optic assemblies uses a condenser lens and a light pipe assembly. The light pipe assembly often incorporates a near field lens to collect and collimate light from the LED through the phenomena of total internal reflection (TIR) to project the light through an emitting end of the light pipe. The condenser lens then projects the light with the desired beam spread onto, for example, a road.

TIR occurs when light attempts to travel from a first medium into a second medium having a lower index of refraction than the first medium. If the light rays strike the second medium at greater than or equal to an appropriate angle measured from the surface normal, known as a critical angle, all of the light is internally reflected back into the first medium. Any light rays that do not strike the second medium at greater than or equal to the critical angle escape into the second medium. The reflected light rays are an indication of the efficiency of the light pipe assembly. Present projector optic assemblies correct for any inefficiency of the light pipe by using a large condenser lens to capture escaped light rays.

Thus, there exists a need for an increased efficiency projector optic assembly.

### SUMMARY

In satisfying the above need, as well as overcoming the enumerated drawbacks and other limitations of the related art, the present invention provides a projector optic assembly for generating and projecting a light beam. The assembly includes a light pipe defining an optical axis and a collection unit, a transition plane, a funneling unit, and an emitting surface. The collection unit extends from the transition plane and includes a portion that defines a coupling unit. A light emitting source is attached to the coupling unit and positioned along the optical axis. The funneling unit extends from the transition plane, in a direction opposite from the collection unit, to the emitting surface. A condenser lens is also positioned along the optical axis and is spaced apart from, and generally opposite, the emitting surface. Preferably, the emitting surface has an area that is smaller than an area at the transition of the collection unit and funneling unit and is selected to maximize the light emitted by the emitting surface, thereby increasing the efficiency of the light pipe. If the area of the emitting surface is too small, however, efficiency will decrease. For example, the area of the emitting surface may be 60-80 percent smaller than the transition area.

In one embodiment, a blocking shield is in contact with the emitting surface. The blocking shield is configured to block light and create a sharp cut-off edge in a projected beam shape. In one embodiment, the blocking shield is configured to block light from exiting a bottom portion of the emitting surface. In other embodiments, the blocking shield may be configured to block light from exiting a top and bottom portions and/or at least one side portion of the emitting surface.

In another embodiment, an exterior surface is defined between the first end of the collection unit and the transition plane. The shape of the exterior surface may be any appropriate shape for total-internally reflecting the light from the light source. For example, the shape may be a straight conical shape, a generally concave shape, a parabolic shape, a ellipsoidal shape, or a combination of these shapes.

The coupling unit is optionally configured to direct the light from the light source towards the emitting surface. In one exemplary embodiment the coupling unit includes a hemispherical or a Cartesian oval central surface radially centered on the optical axis and a generally outwardly extending inner wall running along the optical axis and circumferentially surrounding the central surface. The shape of the outer surface may include, for example, a free form surface, a straight conical shape, a concave shape, a parabolic shape, a ellipsoidal shape, or a combination of these shapes with the sole function of directing the light approximately towards an emitting surface when used with a finite light source.

In still other embodiments, the emitting surface may have a circular shape, a oval shape, or a rectangular shape. In those embodiments with a rectangular shape, the funneling unit includes an upper surface and a lower surface respectively extending from the transition to upper edge and lower edges of the rectangular emitting surface, respectively. Optionally, the lower edge of the emitting surface may be stepped to provide a stepped shape to the projected beam shape.

The condenser lens may be a standard aspherical lens or could be configured as a free form lens to project light from the emitting surface with a desired beam spread onto a road, for example. The desired beam spread may include, for example, a vertical beam spread of 10 to 12 degrees below the optical axis and a horizontal beam spread of up to 40 to 50 degrees to either side of the optical axis. The condenser lens can have plano-convex, plano-concave, concave-convex, or convex-convex surfaces.

In some embodiments, the light pipe may have a focal point between the emitting surface and the condenser lens. The focal point itself has a focal length longer than an axial length of the funneling unit of the light pipe.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a projector optic assembly embodying the principles of the present invention;

FIG. 2 is a perspective view of a second embodiment according to the principles of the present invention;

FIG. 3 is a side section view of the embodiment of FIG. 1; and

FIGS. 4A-4D are front profiles of various examples of an emitting surface as may be used with the present invention.

### DETAILED DESCRIPTION

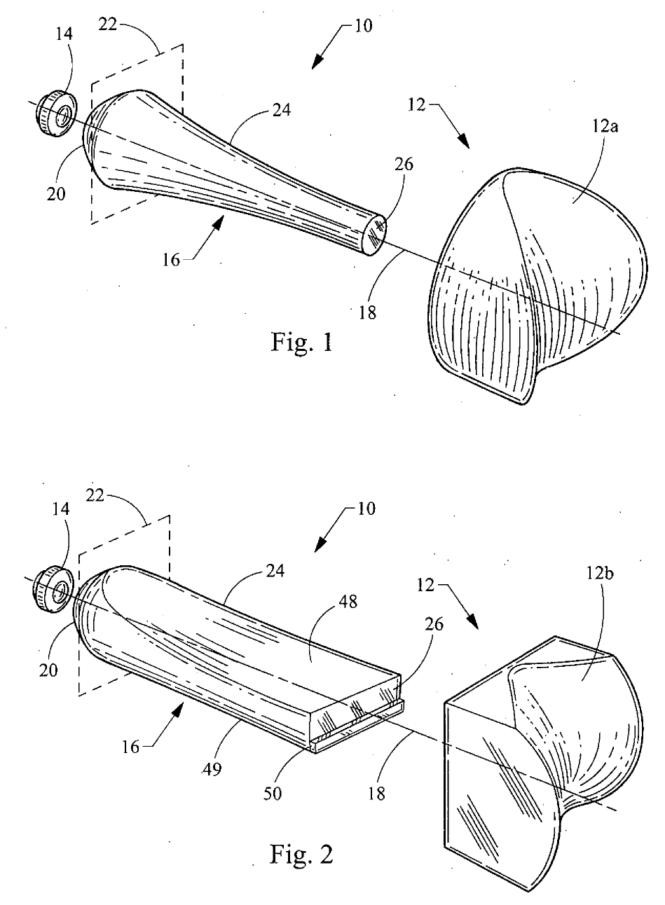

Referring now to FIGS. 1 and 2, two examples of a projector optic assembly embodying the principles of the present invention are illustrated therein and designated at 10. FIG. 1 shows an optic assembly 10 that is substantially circular in transverse cross-section and FIG. 2 shows an optic assembly 10 that is substantially rectangular in cross-section. As its primary components, the projector optic assembly 10 includes a condenser lens 12, a light emitting source 14, and a light pipe 16. The light pipe 16 defines an optical axis 18 and has a collection unit 20 that joins at a transition plane 22 to a funneling unit 24, and also includes an emitting surface 26. The condenser lens 12 is positioned along the optical axis 18 and spaced apart from and generally opposite of the emitting surface 26.

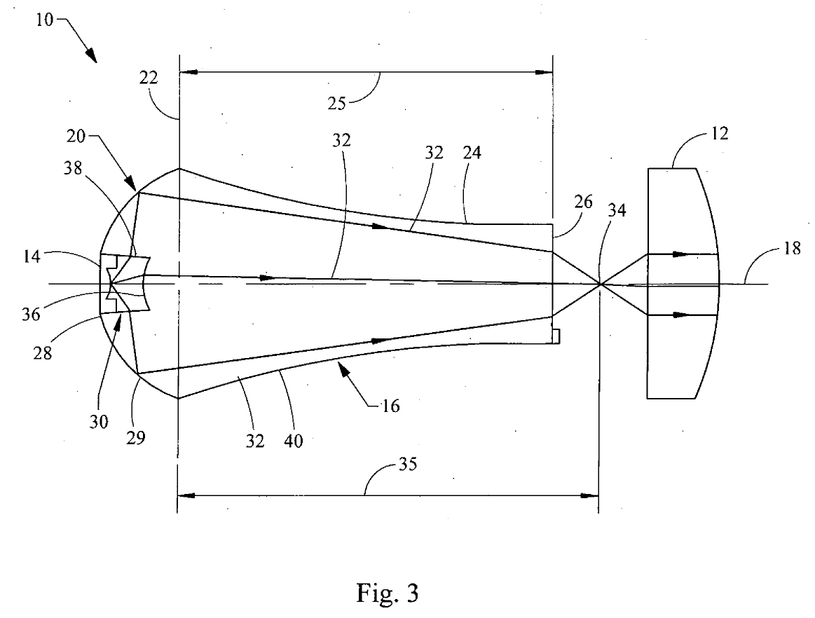

The light pipe 16 is preferably constructed as a single integral unit of an optical grade material such as, but not limited to, polycarbonate, polymethylmethacrylate (PMMA), or glass. Preferably, the light pipe 16 is designed to internally reflect, by the phenomena of total internal reflection (TIR), substantially all rays of light traveling through it from the light emitting source 14 to the emitting surface 26. To achieve this, the index of refraction of the material should be as high as possible, for example, in the range of 1.4-1.8. While it is preferred that the light pipe 16 is composed of one solid material, as shown in FIG. 3, alternatively, the light pipe 16 may be hollow, with a solid outer shell and a fluid or gel filled interior (not shown).

In another embodiment, the light pipe 16 could be a hollow metalized (reflective coating) separate reflector piece. In this embodiment (not shown) the front exit surface of the collector lens 20 at the transition plane 22 may be a portion of a spherical surface whose center will be the focal point 34. Thus, the optic assembly of the collection lens unit 20 and the funneling reflector unit 16 may be assembled from two separate pieces.

Turning now to FIG. 3, a longitudinal sectional view, that is representative of both of the embodiments of FIGS. 1 and 2, is shown. The collection unit 20 defines an exterior surface 29 extending between a first end 28 and the transition plane 22. A portion of the first end 28 has a coupling unit 30. The light emitting source 14 is attached to the coupling unit 30 along the optical axis 18. The collection unit 20 collects light rays 32 from the light source 14 and refracts them through 36 and 38 and reflects the rays 32 through 29 across the transition plane 22 and into the funneling unit 24. The funneling unit 24 directs the light rays 32 to converge at a focal point 34 and to exit through the emitting surface 26. The focal point 34 is preferably located between the emitting surface 26 and the condenser lens 12 as shown. In some embodiments (not shown), the focal point 34 may be located at the emitting surface 26 or within the funneling unit 24. In the example shown, the focal length 35 is approximately 20 mm longer than the axial length 25, but other lengths are possible depending on the needs of a particular application. The light emitting source 14 preferably includes light emitting diodes (LED's), but may also include any other appropriate source such as Lambetian emitters, 2π emitters and fiber optic light tips.

In the example shown, the collection unit 20 is a near field lens (NFL) using TIR to collect and direct as much light as possible from the light emitting source 14 into the funneling unit 24. There are multiple variations of NFLs, with the collection unit 20 of FIG. 3 showing an axisymmetric NFL. In the example shown, a diameter of the first end 28 is smaller than a diameter at the transition plane 22 of the collector 20. The shape of the exterior surface 29 is configured to ensure the light rays 32 emitted by the light source 14 are internally reflected. The light rays 32 are internally reflected by striking the exterior surface 29 at angles equal or greater than a critical angle, which is based on the index of refraction of the material of the collection unit 20 and the index of refraction of the material external to the collection unit 20. In most cases, the external material will be air. To ensure all of the light rays 32 strike at or less than the critical angle, the exterior surface 29 may be appropriately shaped with, for example, a free form surface, a conical, concave, parabolic, and ellipsoidal shape or combinations thereof. As one skilled in the art will readily appreciate, the precise shape necessary will depend on the geometry and needs of each application.

The coupling unit 30 of the collection unit 20 also includes, for example, a generally Cartesian oval outwardly convex central surface 36 that is radially centered on the optical axis 18. In addition, a generally outwardly extending inner wall 38 defining an outwardly concave (not shown) or conical surface (shown) runs along the optical axis 18 and circumferentially surrounds the central surface 36. The path of the light rays 32 are bent (i.e. refracted) at the surfaces 36 and 38 shortly after they leave the light source 14 as they enter the collection unit 20. The shape of the surfaces 36 and 38 are configured to optimize the path of the light rays 32 through the collection unit 20.

The funneling unit 24 includes an outer surface 40 extending from the transition plane 22 to the emitting surface 26, the latter having an area smaller than a cross-sectional area of the funneling unit 24 at the transition plane 22. The area of the emitting surface 26 is configured to maximize the light emitted by the emitting surface and increase the efficiency of the funneling unit 24. If the area of the emitting surface 26 is too small, the rays from the emitting surface will exit at greater cone angles requiring larger size condenser lens. When a finite light source is used, some of the light rays (not shown) from the exterior surface 29 may not directly hit the emitting surface 26, but may hit the funnel wall first and then get internally reflected and redirected towards the emitting surface 26. Very few rays (not shown here) hitting the funnel wall close to the transition plane will escape by refraction and become uncontrolled useless light, but the reduction in the efficiency of the light pipe is very negligible due to this light leakage. To reduce the amount of light escaping the emitting surface 26 at reasonable exit cone angles, the area of the emitting surface 26 should be in the range of 60 to 80 percent smaller than the area at the transition plane 22. While these are preferred ranges, other values, outside of this range, are possible. The outer surface 40 of the funneling unit 24 may be shaped to have, for example, an appropriate conical, concave, parabolic, and ellipsoidal shape or combinations thereof. As one skilled in the art will readily appreciate, the precise shape necessary will depend on the geometry and needs of each application.

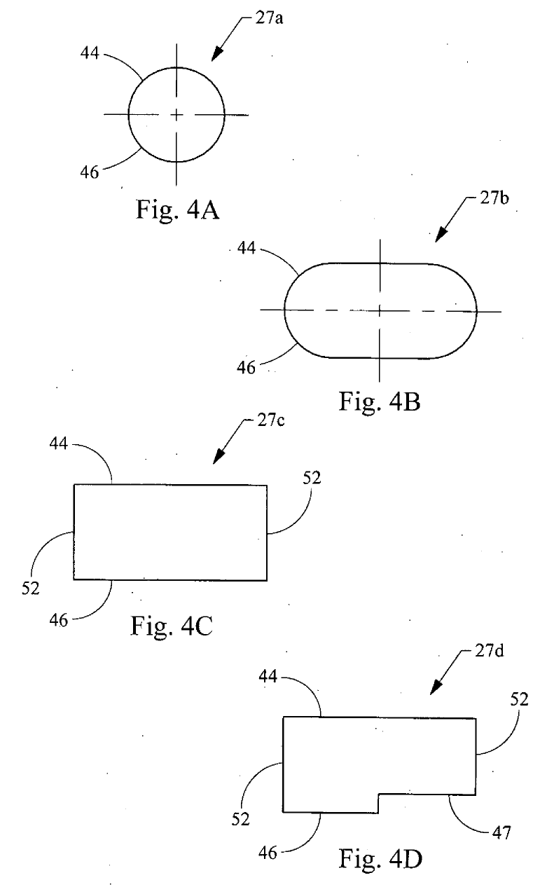

Turning to FIGS. 4A-4D, the emitting surface 26 of the funneling unit 24 has a cross-sectional shape 27 corresponding to a desired beam shape. The shape may include, for example, a generally circular shape 27a, an oval shape 27b, a rectangular shape 27c or other geometric shape. As best shown in FIG. 2, in those embodiments having a generally rectangular shape 27c for the emitting surface 26, the funneling unit 24 also includes an upper surface 48 and a lower surface 49, respectively extending between the transition plane 22 and the upper and lower edges 44 and 46. In all embodiments, the emitting surface has an upper edge 44 and a lower edge 46. The lower edge 46 may, for example, have a stepped shape 27d, and therefore not be symmetrical to the upper surface 44. In the generally rectangular embodiments of FIGS. 4c and 4d, side edges 52 extend between the top and bottom edges 44 and 46.

Returning to FIG. 3, an optional blocking shield 50 is shown so as to be located between the emitting surface 26 and the condenser lens 12. As shown, the blocking shield 50 is located so as to be in contact with the emitting surface 26 and along the lower edge 46 thereof. The blocking shield 50 blocks a portion of light from exiting the emitting surface 26 and creates a sharp cut-off edge in the beam shape. The edge of the blocking shield can be straight or stepped. In the example shown, the blocking shield 50 blocks light from exiting a bottom portion of the emitting surface 26. In other examples, the blocking shield 50 may block light from exiting a top potion or other portions (e.g. sides) of the emitting surface 26.

The condenser lens 12 is an optic unit configured to project the light rays from the emitting surface 26 onto a surface, such as a road, with a desired beam spread. The cross-sectional shape of the condenser lens 12 may or may not match that of the emitting surface 26. FIGS. 1 and 2 show condenser lenses 12a and 12b with circular and square cross-sectional shapes, respectively. The condenser lens 12 may include, but is not limited to, aspheric and free form lenses. The desired beam spread may include, for example, a vertical beam spread of 10 to 12 degrees below the optical axis and a horizontal beam spread up to of around 40 to 50 degrees to either side of the optical axis.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A projector optic assembly for generating and projecting a high gradient beam, the assembly comprising:
a light pipe defining an optical axis and including a collection unit, a transition plane, a funneling unit, and an emitting surface;
the collection unit extending from a first end to the transition plane, a portion of the first end defining a coupling unit having a light source being attached to the coupling unit and positioned along the optical axis, the collection unit being configured to collect light from the light source and direct the light through the transition plane;
the funneling unit including an outer surface extending from the transition plane to the emitting surface;
the emitting surface having an area smaller than a cross-sectional area of the funneling unit at the transition plane thereby maximizing the light emitted by the emitting surface; and
a condenser lens positioned along the optical axis and spaced apart from and generally opposite the emitting surface.

2. The assembly of claim 1 wherein the area of the emitting surface is 60 to 80 percent smaller than the cross-sectional area of the funneling unit at the transition plane.

3. The assembly of claim 1 further comprising a blocking shield located between the emitting surface and the condenser lens to block light and create a sharp cut-off edge in a projected beam shape.

4. The assembly of claim 3 wherein the blocking shield is configured to block light from exiting a bottom portion of the emitting surface.

5. The assembly of claim 3 wherein the blocking shield is in contact with the emitting surface.

6. The assembly of claim 1 wherein on an effective diameter of the first end of the collection unit is smaller than an effective diameter of the collection unit at the transition plane.

7. The assembly of claim 6 further comprising an exterior surface extending between the transition plane and the emitting surface, the exterior surface generally being of a generally straight conical shape, a generally concave shape, a generally parabolic shape, a generally ellipsoidal shape, a free form shape, and combinations thereof.

8. The assembly of claim 1 wherein the coupling unit includes a generally Cartesian oval outwardly convex central surface radially centered on the optical axis.

9. The assembly of claim 8 wherein the coupling unit further includes an inner wall circumferentially surrounding the central surface and generally extending along the optical axis.

10. The assembly of claim 1 wherein the outer surface is formed in the shape of one of a substantially straight conical shape, a substantially concave shape, a substantially parabolic shape, a substantially ellipsoidal shape, a free form shape, and combinations thereof.

11. The assembly of claim 1 wherein the emitting surface is formed in the shape of one of a generally circular shape, a generally oval shape, and a generally rectangular shape.

12. The assembly of claim 11 wherein the funneling unit includes an upper surface and a lower surface respectively extending from the transition plane to upper and lower edges of the emitting surface.

13. The assembly of claim 1 wherein the emitting surface includes an upper edge and a lower edge and the lower edge includes a stepped portion.

14. The assembly of claim 1 wherein the condenser lens is an optic unit configured to project light from the emitting surface onto a road with a desired beam spread.

15. The assembly of claim 14 wherein the desired beam spread includes a vertical beam spread of 10 to 12 degrees below the optical axis and a horizontal beam spread of up to 30 to 50 degrees to either side of the optical axis.

16. The assembly of claim 1 wherein the light pipe defines a focal point located between the emitting surface and the condenser lens.

17. The assembly of claim 16 wherein the light pipe defines a focal length that is longer than an axial length of the funneling unit of the light pipe.

18. The assembly of claim 17 wherein the focal point is located about 20 mm beyond the axial length of the funneling unit.

19. The assembly of claim 1 wherein the condenser lens includes one of a free form lens and an aspheric lens.
